(19) United States
(12) Patent Application Publication
(10) Pub. No.: US 2025/0356260 A1
(43) Pub. Date: Nov. 20, 2025

(54) FEDERATED OBJECT DETECTION LEARNING METHOD BASED ON REPRESENTATION ENHANCEMENT AND WEIGHTED AGGREGATION UNDER CLOUD-EDGE-TERMINAL ENVIRONMENT

(71) Applicant: Zhejiang University of Technology, Hangzhou (CN)

(72) Inventors: Gang Xiao, Hangzhou (CN); Zihao Zhao, Hangzhou (CN); Yuanming Zhang, Hangzhou (CN); Jiacheng Huang, Hangzhou (CN); Zhenbo Cheng, Hangzhou (CN); Xuesong Xu, Hangzhou (CN)

(21) Appl. No.: 19/190,824

(22) Filed: Apr. 28, 2025

(30) Foreign Application Priority Data
May 15, 2024 (CN) 202410602501.0

(51) Int. Cl. G06N 20/00

(52) U.S. Cl. CPC G06N 20/00

(57) ABSTRACT

A federated object detection learning method based on representation enhancement and weighted aggregation under cloud-edge-terminal environment comprises the steps of: 1) building a centralized federated learning framework under cloud-edge-terminal environment; 2) locally conducting representation enhancement training to strengthen model learning for few-shot category after receiving a model from the server at the client; 3) carrying out the weighted aggregation for client models in accordance with sample distribution to obtain the global model after receiving models from all clients at the server. With regard to the problem of existing federated object detection learning on low global model accuracy and weak generalization ability, the present invention can improve the accuracy and generalization ability of global object detection model.

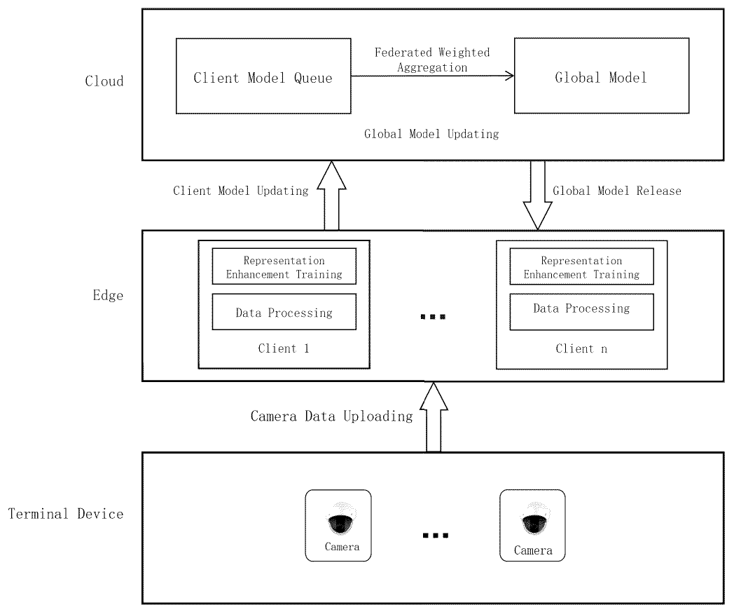

### CROSS REFERENCE TO RELATED APPLICATIONS

The present application claims the benefit of Chinese Patent Application No. 202410602501.0 filed on May 15, 2024. All the above are hereby incorporated by reference in their entirety.

### TECHNICAL FIELD

The present invention relates to the field of cloud-edge-terminal, federated learning, object detection, etc., especially providing a federated object detection learning method based on representation enhancement and weighted aggregation under cloud-edge-terminal environment.

### BACKGROUND ART

Cloud-edge-terminal computing environment is an emerging data processing and storage platform, with a purpose to combine cloud computing with edge computing so as to achieve more efficient data processing and decision support. “Cloud” refers to cloud server which provides data computing, storage, management, analysis and other services, and the cloud's flexible resource allocation may reduce the cost and risk of edge computing; “edge” refers to edge server which connects the terminal to the cloud, to achieve the high-speed data transmission and collaborative processing, reduce the burden of the cloud, and improve the system efficiency; “terminal” refers to sensors, intelligent terminals, etc., and they are distributed in various industries and fields, able to generate and collect large amounts of data at any time. These terminals are connected to the edge server via the internet, which can achieve the near real-time decision and provide the cloud with the accurate data support.

Federated learning is a distributed machine learning paradigm with privacy protection, and federated learning participants only upload parameters rather than data during training, with a purpose to enable distributed participants to collaborate on model training for machine learning without disclosing private data to other participants. By deploying the federated learning framework under cloud-edge-terminal environment, the edge server trains the local model and then uploads it to the central cloud server, to perform global model updating, and form a centralized and distributed training network structure; when protecting data privacy, it can give full play to the advantages of the cloud, edge and terminal, reduce data transmission delay, and improve computational efficiency and real-time performance.

The object detection task focuses on the category and location of specific target objects in the picture. One detection task contains two subtasks: the first is to output the category information of the target, which belongs to the classification task; the second is to output the specific location information of the target, which belongs to the positioning task. Federated learning is applied in object detection model training, which can break the isolated data island to enable efficient utilization of mass data under the premise of protecting the client data privacy. When the client data distribution is relatively uniform, the previous federated object detection learning can achieve good performance; however, in reality, the sample distribution among different data sets is often heterogeneous. At this point, the optimal value of the loss function for each client is different from the global model, which leads to the decrease in the performance of the global model obtained through aggregation. In order to alleviate such problem, according to Liu et al. (International Conference on Vision, Image and Signal Processing, 2019), the mask is generated for the model by calculating the divergence among the weight distributions of client model at the server, to restrain those abnormal weights. Sarkar (International Joint Conference on Artificial Intelligence, 2020) introduces Fed-Focal loss function, so that the client can weigh the loss of the well-classified samples during training, to achieve the robust processing of Non-IID data in combination with adjustable sampling framework. In accordance with each round of communication by Ge et al. (International Conference on Control and Intelligent Robotics, 2022), after completing the local training, the client randomly receives a model from another client, and then uses the local data to train the received model, so that each client model can additionally learn from data sets of different clients to mitigate the impact of heterogeneous sample distribution. Zhou et al. (IEEE Transactions on Industrial Informatics, 2022) learn the prototype of each category based on the features extracted from the network, and then construct the classifier according to the obtained prototype to solve the problem of category unbalance.

However, the existing federated object detection learning algorithm does not optimize the client and server jointly, resulting in low object detection performance accuracy; in addition, the generalization ability is relatively weak, which is not suitable for few-shot data. For this purpose, the present invention provides a federated object detection learning method based on representation enhancement and weighted aggregation under cloud-edge-terminal environment, and jointly optimizes the problem of heterogeneous sample distribution at the client and server, to improve the performance of global model.

### SUMMARY OF THE INVENTION

The present invention provides a federated object detection learning method based on representation enhancement and weighted aggregation under cloud-edge-terminal environment to overcome the shortcomings of existing federated object detection learning on low global model accuracy and weak generalization ability, and the client can strengthen the model learning for few-shot category by enhancing the representation of few-shot category during training; the server sets the appropriate aggregation weight based on the number of client samples and the uniformity of sample distribution, to further alleviate the problem of global model performance reduction caused by heterogeneous sample distribution.

The present invention provides the following technical proposal in order to solve the above technical problems:

A federated object detection learning method based on representation enhancement and weighted aggregation under cloud-edge-terminal environment is composed of the following steps:
1) Building a centralized federated learning framework under cloud-edge-terminal environment;
2) Locally conducting representation enhancement training for the model after receiving a model from the server at the client;
3) Carrying out the weighted aggregation for client models in accordance with sample distribution to obtain the global model after receiving models from all clients at the server.

This present invention performs the representation enhancement training for the client under cloud-edge-terminal collaboration environment, carries out the federated weighted aggregation at the server, continuously iterates the above training process until the convergence of global model, completes the federated object detection learning, and finally obtains a object detection model which can be applied in practice.

Further, the process of Step 1) is shown below: building the centralized federated learning framework under cloud-edge-terminal environment: The server in the centralized federated learning framework is deployed at the cloud, and the client is deployed at the edge node; the data required for training are acquired by depending on terminal cameras and are uploaded to the corresponding client; the pictures with detection target are screened at each client, the target in the picture is marked in the form of frames, and the annotation information contains the boundary box location and category of the target; then the pictures of electric vehicles marked at the client, and the annotation information are classified into the folder, to prepare for subsequent federated learning training.

Further, the process of Step 2) is shown below: the client takes yolov1 as the object detection algorithm, and locally trains the data set processed in Step (1) by depending on the global model downloaded from the server; for the problem of global model performance reduction caused by heterogeneous sample distribution, the client enhances the representation of few-shot category by using the unbalance softmax function during training, and the enhancement model conducts the gradient renewal for few-shot category at the time of making the loss to strengthen the model learning for few-shot category.

Preferably, the training process of Step 2) is shown below:
2.1) Setting the category unbalance factor

In order to enhance the model learning for few-shot category at the client, it is necessary to use the category unbalance factor to enhance the features of few-shot category, and take the proportion of each category to the sample count as the category unbalance factor;

Firstly, the client calculates the proportion

$${P}_{i}^{k}$$

of category i based on the proportion of each category to the sample count:

$${p}_{i}^{k} = \frac{{num}_{i}^{k}}{{sum}^{k}} \qquad ( 1 )$$

Where,

$${p}_{i}^{k}$$

is the proportion of category i in the samples of client k;

$${num}_{i}^{k}$$

is the quantity of category i in the samples of client k; sum^{k} is the number of samples in client k;

Then, by rows, the client sequentially concatenates

$${P}_{i}^{k}$$

into the n×1 unbalance factor vector P^{k}:

$${P}^{k} ∈ {ℝ}^{n \times 1} \qquad ( 2 )$$

Where P^{k} is the category unbalance factor of client k; n is the number of categories, and

$${\sum }_{i = 1}^{n} {P}_{i}^{k}$$

is 1; at the same time, all clients send their own P^{k} and sum^{k} to the server, so that the server sets its own aggregation weight in Step 3;
2.2) Sample representation extraction

The vector output by the training sample through the network is the sample's representation vector Pred:

$$Pred = f ( x ; ω ) \qquad ( 3 )$$

Where, the sample x obtains the output Pred∈ [symbol] ^{n×1} through the network f; n is the number of categories; ω is the parameter of network f;
2.3) Representation enhancement

After the unbalance factor P^{k} of client k is obtained in 2.1), P^{k} is combined with softmax function to get the unbalance softmax function and calculate the score of each category:

$${score}_{i}^{k} = \frac{{P}_{i}^{k} {e}^{{pred}_{i}^{k}}}{{\sum }_{j = 1}^{n} {P}_{j}^{k} {e}^{{pred}_{j}^{k}}} \qquad ( 4 )$$

Where,

$${P}_{i}^{k}$$

is the unbalance factor of category i at client k;

$${pred}_{i}^{k}$$

is the value of category i in Pred output by the training sample x through the network model of client k, the unbalance softmax function scales

$${z}_{i}^{k}$$

in sample representation through the unbalance factor to obtain

$${score}_{i}^{k} ,$$

and finally, by rows,

$${score}_{i}^{k}$$

is concatenated into the vector after representation enhancement Score^{k}∈ [symbol] ^{n×1};
2.4) Loss optimization

Score^{k} after sample representation enhancement is obtained at client k, then the actual value of the sample and Score^{k} are used to calculate the loss, and the enhancement model conducts the gradient renewal for few-shot category, to strengthen the model learning for few-shot category; during training, the optimal network model is iterated by continuously minimizing the loss function Loss of yolov1;

Loss is composed of three parts, such as position error loss function, confidence error loss function, and classification error loss function; the calculation formula is as follows:

$$Loss = Pos + Con + Cls \qquad ( 5 )$$

The position error loss function is required to ensure that the position predicted by the model for each grid unit is as close as possible to the actual position, which is defined as follows:

$$Pos = {λ}_{c} {\sum }_{i = 0}^{{S}^{2}} {\sum }_{j = 0}^{B} {1}_{i j}^{obj} [ {( {x}_{i} − {\overline{x}}_{ι} )}^{2} + {( {y}_{i} − {\overline{y}}_{ι} )}^{2} + {( {\sqrt{w}}_{i} − \sqrt{{\overline{w}}_{l}} )}^{2} + {( {\sqrt{h}}_{i} − \sqrt{{\overline{h}}_{l}} )}^{2} ] \qquad ( 6 )$$

Where, S² represents S*S grids; B is the number of categories in the box; (xᵢ, yᵢ) is the central point coordinate of the predicted bbox; (x̅_{ι}, y̅_{ι}) is the center point coordinate of the annotated bbox; w and h are respectively the width and height of the predicted bbox; w̅_{ι} and h̅_{ι} are respectively the width and height of the annotated bbox;

$${1}_{i j}^{obj}$$

represents the object in bbox j of grid i;

The confidence error loss function is required to ensure that these confidence predictions are matched with the actual situation, to improve the model's adaptability to different scenarios, which is defined as follows:

$$Con = {\sum }_{i = 0}^{{S}^{2}} {\sum }_{j = 0}^{B} {1}_{i j}^{obj} {( {C}_{i} − {\overline{C}}_{ι} )}^{2} + {λ}_{noobj} {\sum }_{i = 0}^{{S}^{2}} {\sum }_{j = 0}^{B} {1}_{i j}^{noobj} {( {C}_{i} − {\overline{C}}_{ι} )}^{2} \qquad ( 7 )$$

Where, S² represents S*S grids; B is the number of categories in the box; Cᵢ is confidence score generated through the network; C̅_{ι} is the intersection-over-union of the predicted and annotated boxes;

$${1}_{i j}^{obj}$$

represents the object in bbox j of grid i;

$${1}_{i j}^{noobj}$$

represents that there is no object in bbox j of grid i;

The category error loss function is required to ensure that these category predictions are as accurate as possible, which is defined as follows:

$$Cls = {\sum }_{i = 0}^{{S}^{2}} {1}_{i j}^{obj} {\sum }_{c ϵ classes} ( {p}_{i} ( c ) - {\overline{p}}_{ι} ( c ) ) \qquad ( 8 )$$

Where, S² represents S*S grids;

$${1}_{i j}^{obj}$$

represents that there is an object in bbox j of grid i; pᵢ(c) is the value of category c corresponding to Pred output by grid i through the network; p̅_{ι}(c) is the actual value of category c, the client uses

$${score}_{c}^{k}$$

to replace the new loss function constructed by pᵢ(c), and the optimal network model is iterated by minimizing the new loss function during training;
2.5) Uploading the trained model parameters to the server at the client after the completion of local training.

Further, in Step 3), after receiving the model parameters of all clients participating in the training, the server sets the aggregation weight for each client according to the uniformity of sample distribution at each client and the client sample count, the aggregation weight is composed of two parts such as sample distribution aggregation weight and sample count aggregation weight, and the implementation process is as follows:
3.1) Setting the sample distribution aggregation weight

The client with relatively uniform sample distribution plays a promoting role in the generalization performance of the global model, the server sets larger aggregation weights for such client, and the process of calculating sample distribution aggregation weight is as follows:

Firstly, according to the sample distribution sent by each client in 2.1), the server calculates the KL divergency KL^{k} between uniform distribution and sample distribution of each client:

$${KL}^{k} {\sum }_{i = 1}^{n} {P}_{i}^{k} log ( \frac{{P}_{i}^{k}}{{q}_{i}} ) \qquad ( 9 )$$

Where, KL^{k} is the KL divergency between uniform distribution and sample distribution of client k (the less it is, the more uniform the sample distribution is); n is the number of categories;

$${P}_{i}^{k}$$

is the proportion of category i at client k to the sample quantity; qᵢ is the proportion of category i at the time of uniform distribution, and is obtained through 1/n;

The less KL^{k} value is, the more uniform the sample distribution is; therefore, it is required to carry out the inverted operation for KL^{k} in order to set larger weights for clients with more uniform sample distribution;

$${KL}_{r}^{k} = \frac{{\sum }_{k = 1}^{n} {KL}^{k}}{{KL}^{k}} \qquad ( 10 )$$

Where,

$${KL}_{r}^{k}$$

is the results of the inverted operation for KL^{k} at client k; KL^{k} is the KL divergency between uniform distribution and sample distribution of client k;

$${\sum }_{k = 1}^{n} {KL}^{k}$$

is the sum of KL^{k} of all clients;

Finally, the sample distribution aggregation weight

$${W}_{d}^{k}$$

is obtained based on Formula (13):

$${W}_{d}^{k} = \frac{{KL}_{r}^{k}}{{\sum }_{k = 1}^{n} {KL}_{r}^{k}} \qquad ( 11 )$$

Where,

$${W}_{d}^{k}$$

is the sample distribution aggregation weight of client k;

$${KL}_{r}^{k}$$

is the results of the inverted operation for KL^{k} at client k;

$${\sum }_{k = 1}^{n} {KL}_{r}^{k}$$

is the sum of

$${KL}_{r}^{k}$$

of all clients;
3.2) Setting the sample count aggregation weight

Due to different overfitting and strong generalization ability, the client with larger sample count plays a promoting role in the performance of the global model, and the server sets larger weights for such client;

The server sets the sample count aggregation weight

$${W}_{n}^{k}$$

according to the sample count of each client:

$${W}_{n}^{k} = \frac{{N}_{k}}{{N}_{s}} \qquad ( 12 )$$

Where,

$${W}_{n}^{k}$$

is the sample count aggregation weight of client k; Nₖ is the number of samples at client k; Nₛ is the number of samples at all clients;
3.3) Setting the final aggregation weight

The server integrates the sample distribution aggregation weight and sample count aggregation weight, and sets the final aggregation weight for clients:

$${W}^{k} = 0.4 \times {W}_{d}^{k} + 0.6 \times {W}_{n}^{k} \qquad ( 13 )$$

Where, W^{k} is the final aggregation weight of client k;

$${W}_{d}^{k}$$

is the sample distribution aggregation weight of client k;

$${W}_{n}^{k}$$

is the sample count aggregation weight of client k;
3.4) Federated weighted aggregation

After obtaining the aggregation weight of each client, the server uses the federated weighted aggregation algorithm to conduct the weighted aggregation for these model parameters, and the federated weighted aggregation algorithm is as follows:

$${ω}_{t}^{glob} = {\sum }_{k = 1}^{m} {W}^{k} {ω}_{t}^{k} \qquad ( 14 )$$

Where,

$${ω}_{t}^{k}$$

is the model parameter of client k; m is the number of clients participating in training;

$${ω}_{t}^{glob}$$

is the global model parameter obtained through aggregation after the completion of communication t, and the server uses the result to update the global model;
3.5) Releasing the updated global model to all clients at the server to complete this round of communication

The beneficial effect of the present invention is shown below: For the problem of existing federated object detection learning on low global model accuracy and weak generalization ability, the present invention provides a federated object detection learning method based on representation enhancement and weighted aggregation under cloud-edge-terminal environment. The edge client first strengthens the model learning for few-shot category through representation enhancement training, and only needs to upload the model parameters and sample distribution to the cloud server after the completion of training, and then the cloud server conducts the weighted aggregation for client models based on sample distribution, to liberate the computing power of cloud servers, reduce data transmission costs between cloud servers and edge clients, and improve the accuracy and generalization ability of global target detection model.

### BRIEF DESCRIPTION OF THE DRAWINGS

The sole FIGURE is the federated object detection learning framework based on representation enhancement and weighted aggregation under cloud-edge-terminal environment.

### DETAILED DESCRIPTION

The present invention is further explained in conjunction with drawings.

A federated object detection learning method based on representation enhancement and weighted aggregation under cloud-edge-terminal environment is composed of the following steps:
1) Building a centralized federated learning framework under cloud-edge-terminal environment;

The process of Step 1) is shown below: building the centralized federated learning framework under cloud-edge-terminal environment: The server in the centralized federated learning framework is deployed at the cloud, and the client is deployed at the edge node; the data required for training are acquired by depending on terminal cameras and are uploaded to the corresponding client; the pictures with detection target are screened at each client, the target in the picture is marked in the form of frames, and the annotation information contains the boundary box location and category of the target; then the pictures of electric vehicles marked at the client, and the annotation information are classified into the folder, to prepare for subsequent federated learning training.
2) Locally conducting representation enhancement training for the model after receiving a model from the server at the client;

The process of Step 2) is shown below:

The client takes yolov1 as the object detection algorithm, and locally trains the data set processed in Step (1) by depending on the global model downloaded from the server; for the problem of global model performance reduction caused by heterogeneous sample distribution, the client enhances the representation of few-shot category by using the unbalance softmax function during training, and the enhancement model conducts the gradient renewal for few-shot category at the time of making the loss to strengthen the model learning for few-shot category.

Preferably, the training process of Step 2) is shown below:
2.1) Setting the category unbalance factor

In order to enhance the model learning for few-shot category at the client, it is necessary to use the category unbalance factor to enhance the features of few-shot category, and take the proportion of each category to the sample count as the category unbalance factor;

Firstly, the client calculates the proportion

$${P}_{i}^{k}$$

of category i based on the proportion of each category to the sample count:

$${p}_{i}^{k} = \frac{{num}_{i}^{k}}{{sum}^{k}} \qquad ( 1 )$$

Where,

$${p}_{i}^{k}$$

is the proportion of category i in the samples of client k;

$${num}_{i}^{k}$$

is the quantity of category i in the samples of client k; sum^{k} is the number of samples in client k;

Then, by rows, the client sequentially concatenates

$${P}_{i}^{k}$$

into the n×1 unbalance factor vector P^{k}:

$${P}^{k} ∈ {ℝ}^{n \times 1} \qquad ( 2 )$$

Where, P^{k} is the category unbalance factor of client k; n is the number of categories, and

$${\sum }_{i = 1}^{n} {P}_{i}^{k}$$

is 1; at the same time, all clients send their own P^{k} and sum^{k} to the server, so that the server sets its own aggregation weight in Step 3;
2.2) Sample representation extraction

The vector output by the training sample through the network is the sample's representation vector Pred:

$$Pred = f ( x ; ω ) \qquad ( 3 )$$

Where, the sample x obtains the output Pred∈ [symbol] ^{n×1} through the network f; n is the number of categories; ω is the parameter of network f;
2.3) Representation enhancement

After the unbalance factor P^{k} of client k is obtained in 2.1), P^{k} is combined with softmax function to get the unbalance softmax function and calculate the score of each category:

$${score}_{i}^{k} = \frac{{p}_{i}^{k} {e}^{{pred}_{i}^{k}}}{{\sum }_{j = 1}^{n} {P}_{j}^{k} {e}^{{pred}_{j}^{k}}} \qquad ( 4 )$$

Where,

$${P}_{i}^{k}$$

is the unbalance factor of category i at client k;

$${pred}_{i}^{k}$$

is the value of category i in Pred output by the training sample x through the network model of client k, the unbalance softmax function scales

$${z}_{i}^{k}$$

in sample representation through the unbalance factor to obtain

$${score}_{i}^{k} ,$$

and finally, by rows,

$${score}_{i}^{k}$$

is concatenated into the vector after representation enhancement Score^{k}∈ [symbol] ^{n×1};
2.4) Loss optimization

Score^{k} after sample representation enhancement is obtained at client k, then the actual value of the sample and Score^{k} are used to calculate the loss, and the enhancement model conducts the gradient renewal for few-shot category, to strengthen the model learning for few-shot category; during training, the optimal network model is iterated by continuously minimizing the loss function Loss of yolov1;

Loss is composed of three parts, such as position error loss function, confidence error loss function, and classification error loss function; the calculation formula is as follows:

$$Loss = Pos + Con + Cls \qquad ( 5 )$$

The position error loss function is required to ensure that the position predicted by the model for each grid unit is as close as possible to the actual position, which is defined as follows:

$$Pos = {λ}_{c} {\sum }_{i = 0}^{{S}^{2}} {\sum }_{j = 0}^{B} {1}_{i j}^{obj} [ {( {x}_{i} − \overline{{x}_{ι}} )}^{2} + {( {y}_{i} − \overline{{y}_{ι}} )}^{2} + {( {\sqrt{w}}_{i} − \sqrt{{\overline{w}}_{ι}} )}^{2} + {( {\sqrt{h}}_{i} − \sqrt{{\overline{h}}_{ι}} )}^{2} ] \qquad ( 6 )$$

Where, S² represents S*S grids; B is the number of categories in the box; (xᵢ, yᵢ) is the central point coordinate of the predicted bbox; (x̅_{ι}, y̅_{ι}) is the center point coordinate of the annotated bbox; w and h are respectively the width and height of the predicted bbox; w̅_{ι} and h̅_{ι} are respectively the width and height of the annotated bbox;

$${1}_{i j}^{obj}$$

represents the object in bbox j of grid i;

The confidence error loss function is required to ensure that these confidence predictions are matched with the actual situation, to improve the model's adaptability to different scenarios, which is defined as follows:

$$Con = {\sum }_{i = 0}^{{S}^{2}} {\sum }_{j = 0}^{B} {1}_{i j}^{obj} {( {C}_{i} − {\overline{C}}_{ι} )}^{2} + {λ}_{noobj} {\sum }_{i = 0}^{{S}^{2}} {\sum }_{j = 0}^{B} {1}_{i j}^{noobj} {( {C}_{i} − {\overline{C}}_{ι} )}^{2} \qquad ( 7 )$$

Where, S² represents S*S grids; B is the number of categories in the box; Cᵢ is confidence score generated through the network; C̅_{ι} is the intersection-over-union of the predicted and annotated boxes;

$${1}_{i j}^{obj}$$

represents the object in bbox j of grid i;

$${1}_{i j}^{noobj}$$

represents that there is no object in bbox j of grid i;

The category error loss function is required to ensure that these category predictions are as accurate as possible, which is defined as follows:

$$Cls = {\sum }_{i = 0}^{{S}^{2}} {1}_{i j}^{obj} {\sum }_{c ϵ classes} ( {p}_{i} ( c ) - {\overline{p}}_{i} ( c ) ) \qquad ( 8 )$$

Where, S² represents S*S grids;

$${1}_{i j}^{obj}$$

represents that there is an object in bbox j of grid i; pᵢ(c) is the value of category c corresponding to Pred output by grid i through the network; p̅_{ι}(c) is the actual value of category c, the client uses

$${score}_{c}^{k}$$

to replace the new loss function constructed by pᵢ(c), and the optimal network model is iterated by minimizing the new loss function during training;
2.5) Uploading the trained model parameters to the server at the client after the completion of local training.
3) Carrying out the weighted aggregation for client models in accordance with sample distribution to obtain the global model after receiving models from all clients at the server.

In Step 3), after receiving the model parameters of all clients participating in the training, the server sets the aggregation weight for each client according to the uniformity of sample distribution at each client and the client sample count, the aggregation weight is composed of two parts such as sample distribution aggregation weight and sample count aggregation weight, and the implementation process is as follows:
3.1) Setting the sample distribution aggregation weight

The client with relatively uniform sample distribution plays a promoting role in the generalization performance of the global model, the server sets larger aggregation weights for such client, and the process of calculating sample distribution aggregation weight is as follows:

Firstly, according to the sample distribution sent by each client in 2.1), the server calculates the KL divergency KL^{k} between uniform distribution and sample distribution of each client:

$$K {L}^{k} = {\sum }_{i = 1}^{n} {P}_{i}^{k} log ( \frac{{P}_{i}^{k}}{{q}_{i}} ) \qquad ( 9 )$$

Where, KL^{k} is the KL divergency between uniform distribution and sample distribution of client k (the less it is, the more uniform the sample distribution is); n is the number of categories;

$${P}_{i}^{k}$$

is the proportion of category i at client k to the sample quantity; qᵢ is the proportion of category i at the time of uniform distribution, and is obtained through 1/n;

The less KL^{k} value is, the more uniform the sample distribution is; therefore, it is required to carry out the inverted operation for KL^{k} in order to set larger weights for clients with more uniform sample distribution;

$$K {L}_{r}^{k} = \frac{{\sum }_{k = 1}^{n} K {L}^{k}}{K {L}^{k}} \qquad ( 10 )$$

Where,

$$K {L}_{r}^{k}$$

is the results of the inverted operation for KL^{k} at client k; KL^{k} is the KL divergency between uniform distribution and sample distribution of client k;

$${\sum }_{k = 1}^{n} K {L}^{k}$$

is the sum of KL^{k} of all clients;

Finally, the sample distribution aggregation weight

$${W}_{d}^{k}$$

is obtained based on Formula (13):

$${W}_{d}^{k} = \frac{K {L}_{r}^{k}}{{\sum }_{k = 1}^{n} K {L}_{r}^{k}} \qquad ( 11 )$$

Where,

$${W}_{d}^{k}$$

is the sample distribution aggregation weight of client k;

$${KL}_{r}^{k}$$

is the results of the inverted operation for KL^{k} at client k;

$${\sum }_{k = 1}^{n} {KL}_{r}^{k}$$

is the sum of

$${KL}_{r}^{k}$$

of all clients;
3.2) Setting the sample count aggregation weight

Due to different overfitting and strong generalization ability, the client with larger sample count plays a promoting role in the performance of the global model, and the server sets larger weights for such client;

The server sets the sample count aggregation weight

$${W}_{n}^{k}$$

according to the sample count of each client:

$${W}_{n}^{k} = \frac{{N}_{k}}{{N}_{s}} \qquad ( 12 )$$

Where,

$${W}_{n}^{k}$$

is the sample count aggregation weight of client k; Nₖ is the number of samples at client k; Nₛ is the number of samples at all clients;
3.3) Setting the final aggregation weight

The server integrates the sample distribution aggregation weight and sample count aggregation weight, and sets the final aggregation weight for clients:

$${W}^{k} = 0.4 \times {W}_{d}^{k} + 0.6 \times {W}_{n}^{k} \qquad ( 13 )$$

Where, W^{k} is the final aggregation weight of client k;

$${W}_{d}^{k}$$

is the sample distribution aggregation weight of client k;

$${W}_{n}^{k}$$

is the sample count aggregation weight of client k;
3.4) Federated weighted aggregation

After obtaining the aggregation weight of each client, the server uses the federated weighted aggregation algorithm to conduct the weighted aggregation for these model parameters, and the federated weighted aggregation algorithm is as follows:

$${ω}_{t}^{glob} = {\sum }_{k = 1}^{m} {W}^{k} {ω}_{t}^{k} \qquad ( 14 )$$

Where,

$${ω}_{t}^{k}$$

is the model parameter of client k; m is the number of clients participating in training;

$${ω}_{t}^{glob}$$

is the global model parameter obtained through aggregation after the completion of communication t, and the server uses the result to update the global model.

In this embodiment, the entry of electric vehicles into elevators is one of the important causes of serious accidents in elevators. How to quickly detect the entry of electric vehicles into elevators is the key problem that the smart elevator needs to solve. The present invention is combined with the entry of electric vehicles into elevators, and is further explained by referring to the sole FIGURE, comprising the steps of:
1) Building a federated learning framework under cloud-edge-terminal environment

Firstly, the cloud-edge-terminal collaboration platform is built, with the unit that has the demand of detecting the entry of electric vehicles into elevators as the cloud, multiple elevator service providers as edge nodes, and cameras as terminal devices.

Secondly, the centralized federated learning framework is built under cloud-edge-terminal environment: The server in the centralized federated learning framework is deployed at the cloud, and the client is deployed at the edge node. The electric vehicle picture data required for training are acquired by depending on terminal cameras and are uploaded to the corresponding client; the pictures of electric vehicles are manually screened at each client, the electric vehicle in the picture is marked in the form of frames, and the annotation information contains the boundary box location and model/category of the electric vehicle; then the pictures of electric vehicles marked at the client, and the annotation information are classified into the folder, to prepare for subsequent federated learning training.
2) Representation enhancement training at the client

Due to the different environments where elevators are located, the distribution of electric vehicle models collected by each client inside the elevator may also be different. In order to alleviate the global model performance reduction caused by heterogeneous electric vehicle model/category distribution of each client, before the training, each client sets the sample unbalance factor according to Formulas (1) and (2), and then starts the training. During the training, it enters the sample in the network model to obtain the sample representation based on Formula (3). The unbalance factor is used to enhance the representation of few-shot category based on Formula (4) to strengthen the network learning of few-shot category. Finally, continuously iterating the loss function of Formula (5) narrows the difference between the predicted value and the actual value, so that the calculated prediction results continuously approach the actual results, thus making the object detection of each client more accurate.
3) Federated weighted aggregation at the server

After receiving the model parameters of all clients participating in the training, the server evaluates the uniformity of sample distribution at each client according to Formula (9), and then sets larger sample distribution aggregation weights for clients with more uniform distribution in accordance with Formula (11). The server sets larger sample count aggregation weights for clients with greater sample count based on Formula (12). Next, the server integrates the sample distribution aggregation weight and sample count aggregation weight, and sets the final aggregation weight for each client through Formula (13), to further alleviate the global model performance reduction caused by heterogeneous sample distribution of each client. Finally, the server conducts the weighted aggregation for the model parameters of each client based on Formula (14) to obtain the global model parameters and update the global model accordingly.

By continuously repeating the above federated learning process, the server eventually gets a high-performance detection model for the entry of electric vehicles into elevators. During this process, the performance of global model is ensured while the data privacy and security of all parties are protected.

The content described in the embodiment of the specifications is just the enumeration of the implementation form of the invention concept, and is for illustrative purposes only. The scope of protection of the present invention shall not be considered to be limited to the specific forms described in this embodiment, and it also involves the equivalent technical means conceived by general technicians in this field according to the concept of the present invention.

What is claimed is:

1. A federated object detection learning method based on representation enhancement and weighted aggregation under cloud-edge-terminal environment, wherein the method comprises the steps of:
1) building a centralized federated learning framework under cloud-edge-terminal environment;
2) locally conducting representation enhancement training for the model after receiving a model from the server at the client;
3) carrying out the weighted aggregation for client models in accordance with sample distribution to obtain the global model after receiving models from all clients at the server.

2. The federated object detection learning method based on representation enhancement and weighted aggregation under cloud-edge-terminal environment described in claim 1, wherein the process of step 1) is shown below:
building the centralized federated learning framework under cloud-edge-terminal environment: the server in the centralized federated learning framework is deployed at the cloud, and the client is deployed at the edge node; the data required for training are acquired by depending on terminal cameras and are uploaded to the corresponding client; the pictures with detection target are screened at each client, the target in the picture is marked in the form of frames, and the annotation information contains the boundary box location and category of the target; then the pictures of electric vehicles marked at the client, and the annotation information are classified into the folder, to prepare for subsequent federated learning training.

3. The federated object detection learning method based on representation enhancement and weighted aggregation under cloud-edge-terminal environment described in claim 1, wherein the process of step 2) is shown below:
the client takes yolov1 as the object detection algorithm, and locally trains the data set processed in step (1) by depending on the global model downloaded from the server; for the problem of global model performance reduction caused by heterogeneous sample distribution, the client enhances the representation of few-shot category by using the unbalance softmax function during training, and the enhancement model conducts the gradient renewal for few-shot category at the time of making the loss to strengthen the model learning for few-shot category.

4. The federated object detection learning method based on representation enhancement and weighted aggregation under cloud-edge-terminal environment described in claim 2, wherein the process of step 2) is shown below:
the client takes yolov1 as the object detection algorithm, and locally trains the data set processed in step (1) by depending on the global model downloaded from the server; for the problem of global model performance reduction caused by heterogeneous sample distribution, the client enhances the representation of few-shot category by using the unbalance softmax function during training, and the enhancement model conducts the gradient renewal for few-shot category at the time of making the loss to strengthen the model learning for few-shot category.

5. The federated object detection learning method based on representation enhancement and weighted aggregation under cloud-edge-terminal environment described in claim 4, wherein the training process of step 2) is shown below:
2.1) setting the category unbalance factor
in order to enhance the model learning for few-shot category at the client, it is necessary to use the category unbalance factor to enhance the features of few-shot category, and take the proportion of each category to the sample count as the category unbalance factor;
firstly, the client calculates the proportion
$${P}_{i}^{k}$$
of category i based on the proportion of each category to the sample count:
$${P}_{i}^{k} = \frac{{num}_{i}^{k}}{{sum}^{k}}$$
where,
$${p}_{i}^{k}$$
is the proportion of category i in the samples of client k;
$${num}_{i}^{k}$$
is the quantity of category i in the samples of client k; sum^{k} is the number of samples in client k;
then, by rows, the client sequentially concatenates
$${P}_{i}^{k}$$
into the n×1 unbalance factor vector P^{k}:
$${P}^{k} ∈ {ℝ}^{n \times 1}$$
where, P^{k} is the category unbalance factor of client k; n is the number of categories, and
$${\sum }_{i = 1}^{n} {P}_{i}^{k}$$
is 1; at the same time, all clients send their own P^{k} and sum^{k} to the server, so that the server sets its own aggregation weight in step 3;
2.2) sample representation extraction
the vector output by the training sample through the network is the sample's representation vector Pred:
$$Pred = f ( x ; ω )$$
where, the sample x obtains the output Pred∈ [symbol] ^{n×1} through the network f; n is the number of categories; ω is the parameter of network f;
2.3) representation enhancement
after the unbalance factor P^{k} of client k is obtained in 2.1), P^{k} is combined with softmax function to get the unbalance softmax function and calculate the score of each category:
$${score}_{i}^{k} = \frac{{P}_{i}^{k} {e}^{{pred}_{i}^{k}}}{{\sum }_{j = 1}^{N} {P}_{j}^{k} {e}^{{pred}_{j}^{k}}}$$
where,
$${P}_{i}^{k}$$
is the unbalance factor of category i at client k;
$${pred}_{i}^{k}$$
is the value of category i in Pred output by the training sample x through the network model of client k, the unbalance softmax function scales
$${z}_{i}^{k}$$
in sample representation through the unbalance factor to obtain
$${score}_{i}^{k} ,$$
and finally, by rows,
$${score}_{i}^{k}$$
is concatenated into the vector after representation enhancement Score^{k}∈ [symbol] ^{n×1};
2.4) loss optimization
Score^{k} after sample representation enhancement is obtained at client k, then the actual value of the sample and Score^{k} are used to calculate the loss, and the enhancement model conducts the gradient renewal for few-shot category, to strengthen the model learning for few-shot category; during training, the optimal network model is iterated by continuously minimizing the loss function Loss of yolov1;
Loss is composed of three parts, such as position error loss function, confidence error loss function, and classification error loss function; the calculation formula is as follows:
$$Loss = Pos + Con + Cls$$
the position error loss function is required to ensure that the position predicted by the model for each grid unit is as close as possible to the actual position, which is defined as follows:
$$Pos = {λ}_{c} {\sum }_{i = 1}^{{S}^{2}} {\sum }_{j = 0}^{B} {1}_{ij}^{obj} [ {( {x}_{i} - \overline{{x}_{ι}} )}^{2} + {( {y}_{i} - \overline{{y}_{ι}} )}^{2} + {( {\sqrt{w}}_{i} - \sqrt{\overline{{w}_{ι}}} )}^{2} + {( {\sqrt{h}}_{i} - \sqrt{\overline{{h}_{ι}}} )}^{2} ]$$
where, S² represents S*S grids; B is the number of categories in the box; (xᵢ, yᵢ) is the central point coordinate of the predicted bbox; (x̅_{ι}, y̅_{ι}) is the center point coordinate of the annotated bbox; w and h are respectively the width and height of the predicted bbox; w̅_{ι} and h̅_{ι} are respectively the width and height of the annotated bbox;
$${1}_{ij}^{obj}$$
represents the object in bbox j of grid i;
the confidence error loss function is required to ensure that these confidence predictions are matched with the actual situation, to improve the model's adaptability to different scenarios, which is defined as follows:
$$C o n = {\sum }_{i = 0}^{{S}^{2}} {\sum }_{j = 0}^{B} {1}_{i j}^{o b j} {( {C}_{i} - \overline{{C}_{ι}} )}^{2} + {λ}_{n o o b j} {\sum }_{i = 0}^{{S}^{2}} {\sum }_{j = 0}^{B} {1}_{i j}^{n o o b j} {( {C}_{i} - {\overline{C}}_{ι} )}^{2}$$
where, S² represents S*S grids; B is the number of categories in the box; Cᵢ is confidence score generated through the network; C̅_{ι} is the intersection-over-union of the predicted and annotated boxes;
$${1}_{i j}^{o b j}$$
represents the object in bbox j of grid i;
$${1}_{i j}^{n o o b j}$$
represents that there is no object in bbox j of grid i;
the category error loss function is required to ensure that these category predictions are as accurate as possible, which is defined as follows:
$$C l s = {\sum }_{i = 0}^{{S}^{2}} {1}_{i j}^{o b j} {\sum }_{c ϵ classes} ( {p}_{i} ( c ) - \overline{{p}_{ι}} ( c ) )$$
where, S² represents S*S grids;
$${1}_{i j}^{o b j}$$
represents that there is an object in bbox j of grid i; pᵢ(c) is the value of category c corresponding to Pred output by grid i through the network; p̅_{ι}(c) is the actual value of category c, the client uses score_{c}^{k} to replace the new loss function constructed by pᵢ(c), and the optimal network model is iterated by minimizing the new loss function during training;
2.5) uploading the trained model parameters to the server at the client after the completion of local training.

6. The federated object detection based on representation enhancement and weighted aggregation under cloud-edge-terminal environment described in claim 1, wherein, in step 3), after receiving the model parameters of all clients participating in the training, the server sets the aggregation weight for each client according to the uniformity of sample distribution at each client and the client sample count, the aggregation weight is composed of two parts such as sample distribution aggregation weight and sample count aggregation weight, and the implementation process is as follows:
3.1) setting the sample distribution aggregation weight
the client with relatively uniform sample distribution plays a promoting role in the generalization performance of the global model, the server sets larger aggregation weights for such client, and the process of calculating sample distribution aggregation weight is as follows:
firstly, according to the sample distribution sent by each client in 2.1), the server calculates the KL divergency KL^{k} between uniform distribution and sample distribution of each client:
$$K {L}^{k} = {\sum }_{i = 1}^{n} {P}_{i}^{k} log ( \frac{{P}_{i}^{k}}{{q}_{i}} )$$
where, KL^{k} is the KL divergency between uniform distribution and sample distribution of client k (the less it is, the more uniform the sample distribution is); n is the number of categories;
$${P}_{i}^{k}$$
is the proportion of category i at client k to the sample quantity; qᵢ is the proportion of category i at the time of uniform distribution, and is obtained through 1/n;
the less KL^{k} value is, the more uniform the sample distribution is; therefore, it is required to carry out the inverted operation for KL^{k} in order to set larger weights for clients with more uniform sample distribution;
$${KL}_{r}^{k} = \frac{{\sum }_{k = 1}^{n} {KL}^{k}}{{KL}^{k}}$$
where,
$$K {L}_{r}^{k}$$
is the results of the inverted operation for KL^{k} at client k; KL^{k} is the KL divergency between uniform distribution and sample distribution of client k;
$${\sum }_{k = 1}^{n} K {L}^{k}$$
is the sum of KL^{k} of all clients;
finally, the sample distribution aggregation weight
$${W}_{d}^{k}$$
is obtained based on formula (13):
$${W}_{d}^{k} = \frac{{KL}_{r}^{k}}{{\sum }_{k = 1}^{n} {KL}_{r}^{k}}$$
where,
$${W}_{d}^{k}$$
is the sample distribution aggregation weight of client k;
$$K {L}_{r}^{k}$$
is the results of the inverted operation for KL^{k} at client k;
$${\sum }_{k = 1}^{n} K {L}_{r}^{k}$$
is the sum of
$${KL}_{r}^{k}$$
of all clients;
3.2) setting the sample count aggregation weight
due to different overfitting and strong generalization ability, the client with larger sample count plays a promoting role in the performance of the global model, and the server sets larger weights for such client;
the server sets the sample count aggregation weight
$${W}_{n}^{k}$$
according to the sample count of each client:
$${W}_{n}^{k} = \frac{{N}_{k}}{{N}_{s}}$$
where,
$${W}_{n}^{k}$$
is the sample count aggregation weight of client k; Nₖ is the number of samples at client k; Nₛ is the number of samples at all clients;
3.3) setting the final aggregation weight
the server integrates the sample distribution aggregation weight and sample count aggregation weight, and sets the final aggregation weight for clients:
$${W}^{k} = 0.4 \times {W}_{d}^{k} + 0.6 \times {W}_{n}^{k}$$
where, W^{k} is the final aggregation weight of client k;
$${W}_{d}^{k}$$
is the sample distribution aggregation weight of client k;
$${W}_{n}^{k}$$
is the sample count aggregation weight of client k;
3.4) federated weighted aggregation
after obtaining the aggregation weight of each client, the server uses the federated weighted aggregation algorithm to conduct the weighted aggregation for these model parameters, and the federated weighted aggregation algorithm is as follows:
$${ω}_{t}^{glob} = {\sum }_{k = 1}^{m} {W}^{k} {ω}_{t}^{k}$$
where
$${ω}_{t}^{k}$$
is the model parameter of client k; m is the number of clients participating in training;
$${ω}_{t}^{glob}$$
is the global model parameter obtained through aggregation after the completion of communication t, and the server uses the result to update the global model;
3.5) releasing the updated global model to all clients at the server to complete this round of communication.

7. The federated object detection based on representation enhancement and weighted aggregation under cloud-edge-terminal environment described in claim 2, wherein, in step 3), after receiving the model parameters of all clients participating in the training, the server sets the aggregation weight for each client according to the uniformity of sample distribution at each client and the client sample count, the aggregation weight is composed of two parts such as sample distribution aggregation weight and sample count aggregation weight, and the implementation process is as follows:
3.1) setting the sample distribution aggregation weight
the client with relatively uniform sample distribution plays a promoting role in the generalization performance of the global model, the server sets larger aggregation weights for such client, and the process of calculating sample distribution aggregation weight is as follows:
firstly, according to the sample distribution sent by each client in 2.1), the server calculates the KL divergency KL^{k} between uniform distribution and sample distribution of each client:
$${KL}^{k} = {\sum }_{k = 1}^{n} {P}_{i}^{k} log ( \frac{{P}_{i}^{k}}{{q}_{i}} )$$
where, KL^{k} is the KL divergency between uniform distribution and sample distribution of client k (the less it is, the more uniform the sample distribution is); n is the number of categories;
$${P}_{i}^{k}$$
is the proportion of category i at client k to the sample quantity; qᵢ is the proportion of category i at the time of uniform distribution, and is obtained through 1/n;
the less KL^{k} value is, the more uniform the sample distribution is; therefore, it is required to carry out the inverted operation for KL^{k} in order to set larger weights for clients with more uniform sample distribution;
$${KL}_{r}^{k} = \frac{{\sum }_{k = 1}^{n} {KL}^{k}}{{KL}^{k}}$$
where,
$${KL}_{r}^{k}$$
is the results of the inverted operation for KL^{k} at client k; KL^{k} is the KL divergency between uniform distribution and sample distribution of client k;
$${\sum }_{k = 1}^{n} {KL}^{k}$$
is the sum of KL^{k} of all clients;
finally, the sample distribution aggregation weight
$${W}_{d}^{k}$$
is obtained based on formula (13):
$${W}_{d}^{k} = \frac{{KL}_{r}^{k}}{{\sum }_{k = 1}^{n} {KL}_{r}^{k}}$$
where,
$${W}_{d}^{k}$$
is the sample distribution aggregation weight of client k;
$${KL}_{r}^{k}$$
is the results of the inverted operation for KL^{k} at client k;
$${\sum }_{k = 1}^{n} {KL}_{r}^{k}$$
is the sum of
$${KL}_{r}^{k}$$
of all clients;
3.2) setting the sample count aggregation weight
due to different overfitting and strong generalization ability, the client with larger sample count plays a promoting role in the performance of the global model, and the server sets larger weights for such client;
the server sets the sample count aggregation weight
$${W}_{n}^{k}$$
according to the sample count of each client:
$${W}_{n}^{k} = \frac{{N}_{k}}{{N}_{s}}$$
where,
$${W}_{n}^{k}$$
is the sample count aggregation weight of client k; Nₖ is the number of samples at client k; Nₛ is the number of samples at all clients;
3.3) setting the final aggregation weight
the server integrates the sample distribution aggregation weight and sample count aggregation weight, and sets the final aggregation weight for clients:
$${W}^{k} = 0.4 \times {W}_{d}^{k} + 0.6 \times {W}_{n}^{k}$$
where, W^{k} is the final aggregation weight of client k;
$${W}_{d}^{k}$$
is the sample distribution aggregation weight of client k;
$${W}_{n}^{k}$$
is the sample count aggregation weight of client k;
3.4) federated weighted aggregation
after obtaining the aggregation weight of each client, the server uses the federated weighted aggregation algorithm to conduct the weighted aggregation for these model parameters, and the federated weighted aggregation algorithm is as follows:
$${ω}_{t}^{glob} = {\sum }_{k = 1}^{m} {W}^{k} {ω}_{t}^{k}$$
where,
$${ω}_{t}^{k}$$
is the model parameter of client k; m is the number of clients participating in training;
$${ω}_{t}^{glob}$$
is the global model parameter obtained through aggregation after the completion of communication t, and the server uses the result to update the global model;
3.5) releasing the updated global model to all clients at the server to complete this round of communication.
